(19) United States
(12) Patent Application Publication
(10) Pub. No.: US 2016/0189290 A1
(43) Pub. Date: Jun. 30, 2016

(54) DISTRIBUTED GENERATION SYSTEM AND METHOD USING A RENTAL ARTICLE HAVING A FLEXIBLE THIN FILM SOLAR CELL

(71) Applicant: KOREA INSTITUTE OF ENERGY RESEARCH, Daejeon (KR)

(72) Inventors: Seok Hyung Bae, Daejeon (KR); Seo Jeong Han, Chungju-si (KR); Hyun Ik Choi, Chungcheongnam-do (KR); Jae Ho Yun, Daejeon (KR); Seo Young Oh, Gyeonggi-do (KR); Young Joo Eo, Daejeon (KR); Kyung Hee Son, Gyeonggi-do (KR); Chi Hye Bae, Daejeon (KR); Min Hee Park, Daejeon (KR); Jong Wook Kim, Daejeon (KR); Yong Kwan Kim, Gyeonggi-do (KR)

(21) Appl. No.: 14/954,645

(22) Filed: Nov. 30, 2015

(30) Foreign Application Priority Data
Dec. 30, 2014 (KR) 10-2014-0193299

(51) Int. Cl. G06Q 30/06; H02S 10/40

(52) U.S. Cl. CPC G06Q 30/0645; H02S 10/40

(57) ABSTRACT

A distributed generation system and method of using a rental article having a flexible thin film solar cell are disclosed. The distributed generation system of a rental article using a flexible thin film solar cell can include: a rental article which generates electric energy from collected solar energy; and a station which is positioned in a space for renting and returning the rental article, and distributes and transmits electric energy provided from the rental article to a power demand target.

### INCORPORATION BY REFERENCE TO ANY PRIORITY APPLICATIONS

This application claims priority to and the benefit of Korean Patent Application No. 10-2014-0193299, filed on Dec. 30, 2014, the disclosure of which is incorporated herein by reference in its entirety.

### BACKGROUND OF THE INVENTION

1. Field of the Invention

The present invention, at least in some embodiments, relates to a distributed generation system and method of a rental article using a flexible thin film solar cell and, more specifically, to a distributed generation system and method of rental articles using a flexible thin film solar cell, which generates power by attaching a flexible thin film solar cell to rental articles used outdoors, uses the generated power as power driving the rental articles, and provides surplus power to a target requiring a power demand.

2. Description of the Related Art

A solar cell plays a role of converting solar energy into electric energy, and is made of, for example, silicon, gallium arsenide, cadmium telluride, cadmium sulfide, indium phosphide, or composite materials thereof, which are semiconductor materials and, generally, silicon is mainly used.

The solar cell is manufactured by p-n junction of semiconductor materials by a diffusion method, using a photovoltaic effect that a small amount of current flows when receiving light, mostly, a normal solar cell including a wide area p-n junction diode, and serves as a unit solar cell and a battery cell when electromotive force generated on both poles of the p-n junction diode is connected to an external circuit.

Meanwhile, recently, technology development of flexible thin film solar cells excellent in terms of light weight, flexibility, and freedom in design have actively proceeded.

Since such a flexible thin film solar cell is thin and flexible differently from a crystalline solar cell, it is easy to use the flexible thin film solar cell as a power supply source by attaching it to an object which is frequently exposed to sunlight and to which it is difficult to supply power by cables, such as outdoor mobile articles.

Accordingly, there is proposed a distributed generation system and method of a rental article using a flexible thin film solar cell, which generates power by attaching a flexible thin film solar cell to various rental articles used outdoors, uses the generated power as power driving the rental articles, and provides surplus power to a target requiring a power demand. There is Korean Laid-Open Patent No. 10-2011-0076083 as the related technique.

An object of the invention, at least in some embodiments, is to solve the problem described above, such that a rental article to which a flexible solar thin film cell is attached generates power, and it is possible to use the generated power or to provide surplus power of the generated power to a power demand target.

In addition, another object of the invention, at least in some other embodiments, is to achieve reduction of greenhouse gas by generating electric energy from a rental article itself.

### SUMMARY

According to an aspect of the invention, there is provided a distributed generation system of a rental article using a flexible thin film solar cell, including: a rental article which generates electric energy from collected solar energy; and a station which is positioned in a space for renting and returning the rental article, and distributes and transmits electric energy provided from the rental article to a power demand target.

In this case, the rental article may include: a power generating unit which is positioned outside the rental article, collects solar energy, and converts the collected solar energy into electric energy; an energy storing unit which stores the electric energy provided from the power generating unit or the station; and a rental article energy using unit which operates the rental article using the electric energy stored in the rental article energy storing unit.

In this case, the power generating unit may be a flexible thin film solar cell.

In this case, the station may include: an energy connecting unit which receives the electric energy from the rental article energy storing unit, or provides the electric energy to the rental article storing unit; a station energy storing unit which stores the electric energy provided from the rental article energy storing unit, and provides the electric energy to the power demand target; and a station energy using unit which operates the station using the electric energy stored in the station energy storing unit.

In this case, a plurality of rental articles may be prepared, and a plurality of energy connecting units may be provided corresponding to the rental articles.

In this case, the station energy storing unit may receive electric energy from an energy storing unit of a first rental article through a first energy connecting unit, and an energy storing unit of a second rental article may receive the electric energy stored in the station energy storing unit through a second energy connecting unit.

In this case, the rental article may be any one of a bicycle, a parasol, and a cap.

In addition, according to another aspect of the invention, there is provided a distributed generation method of a rental article using a flexible thin film solar cell, including: generating electric energy from solar energy collected in the rental article; storing the generated electric energy in the rental article; using the stored electric energy to operate the rental article; and providing surplus electric energy, which remains after using to operate the rental article, of the stored electric energy to the station.

In this case, the method may further include, after providing surplus electric energy, which remains after using to operate the rental article, of the stored electric energy to the station, providing the electric energy stored in the station to a power demand target.

In this case, the power demand target may be a second rental article.

In this case, the station in providing surplus electric energy, which remains after using to operate the rental article, of the stored electric energy to the station may be a second station positioned in a space different from that of a first station positioned in a space for rental of the rental article, and may be positioned in a space for return of the rental article.

### BRIEF DESCRIPTION OF THE DRAWINGS

FIG. 1 is a schematic diagram illustrating a distributed generation system of a rental article using a flexible thin film solar cell according to some embodiments of the invention;

FIG. 2 is a diagram for explaining a configuration of a rental article in a distributed generation system of a rental article using a flexible thin film solar cell according to some embodiments of the invention;

FIG. 3 is a diagram for explaining a configuration of a station in a distributed generation system of a rental article using a flexible thin film solar cell according to some embodiments of the invention;

FIG. 4 is a diagram for explaining an embodiment of a distributed generation system of a rental article using a flexible thin film solar cell according to some embodiments of the invention;

FIG. 5 is a flowchart illustrating a distributed generation method of a rental article using a flexible thin film solar cell according to some embodiments of the invention; and

FIG. 6 and FIG. 7 are diagrams for explaining embodiments of rental articles in a distributed generation system of a rental article using a flexible thin film solar cell according to some embodiments of the invention.

### DETAILED DESCRIPTION OF CERTAIN EMBODIMENTS

Embodiments of the present invention may be variously modified and may have various embodiments, and specific embodiments will be exemplified in the drawings, and will be described in detail in the detailed description that follows.

However, the invention is not limited to a specific embodiment, and it should be understood that all modifications, equivalents, and substitutions included in the spirit and the technical scope of the invention are included therein. In describing the drawings, similar reference signs are used for similar constituent elements.

When it is mentioned that any constituent elements is “connected” or “coupled” to the other constituent element, it should be understood that the constituent element may be directly connected or coupled to the other constituent element, but there may be another constituent element therebetween. Meanwhile, when it is mentioned that any constituent element is “directly connected” or “directly coupled” to the other constituent element, it should be understood that there is not another constituent element therebetween.

Terms used in the present application are used merely to describe a specific embodiment, and does not tend to limit the invention. Singular expression includes plural expression as long as it does not mean clearly different expression on context. In the present application, terms of “include”, “have”, and the like is to designate that there are characteristics, numerals, steps, operations, constituent elements, components, or combinations thereof, and it should be understood that the terms do not previously exclude existence or additional possibility of one or more other characteristics, numerals, steps, operations, constituent elements, components, or combinations thereof

Hereinafter, preferred embodiments of the invention will be described in more detail with reference to the accompanying drawings. Hereinafter, the same reference signs are used for the same constituent elements on the drawings, and repeated description of the same constituent elements is omitted.

Renewable energy is obtained by converting sunlight, wind, water, geothermal power, rain, and the like into renewable energy as substitution of existing fossil fuel, and includes environment-friendly clean energy, public future energy, and non-exhaustive energy, and various kinds of renewable energy using solar power, wind force, and geothermal power substitute for fossil fuel.

The invention, at least in some embodiments, relates to a technique of converting solar energy collected by a rental article into electric energy to generate power, operating the rental article by the generated power, and supplying surplus power, which remains after operating the rental article, of the generated power to a power demand target.

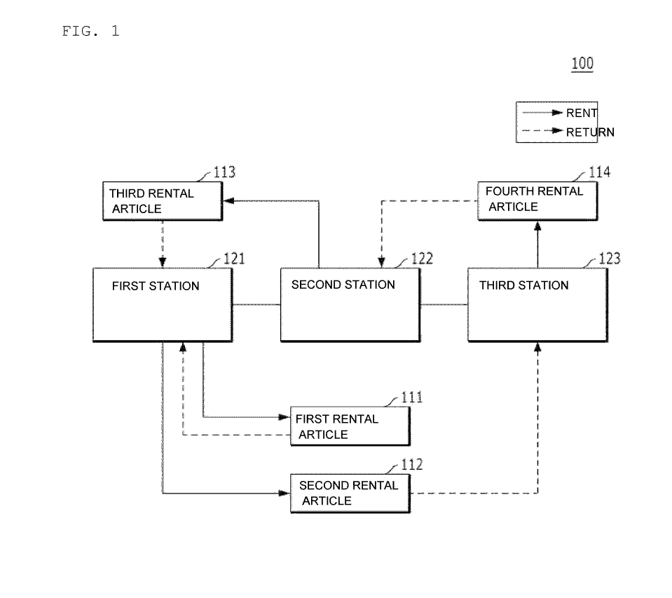

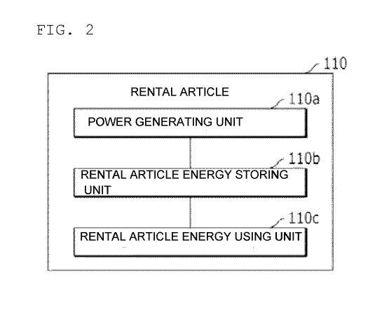

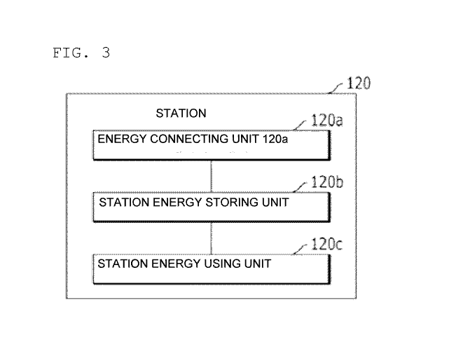

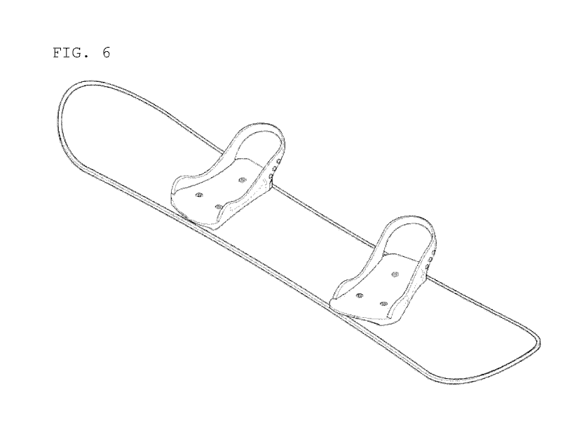

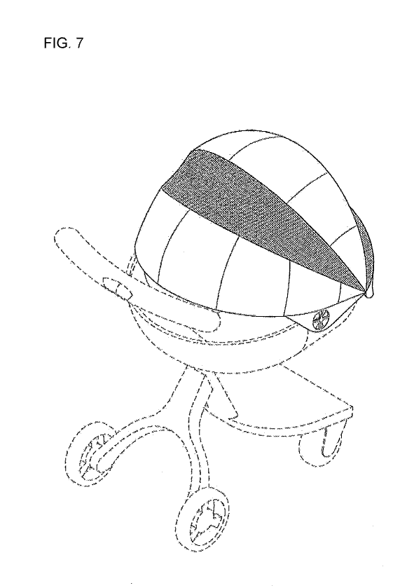

FIG. 1 is a schematic diagram illustrating a distributed generation system of a rental article using a flexible thin film solar cell according to some embodiments of the invention. FIG. 2 is a diagram for explaining a configuration of a rental article in a distributed generation system of a rental article using a flexible thin film solar cell according to some embodiments of the invention. FIG. 3 is a diagram for explaining a configuration of a station in a distributed generation system of a rental article using a flexible thin film solar cell according to some embodiments of the invention. FIG. 6 and FIG. 7 are diagrams for explaining embodiments of a rental article in a distributed generation system of a rental article using a flexible thin film solar cell according to some embodiments of the invention.

Referring to FIG. 1, a distributed generation system 100 of a rental article using a flexible thin film solar cell according to some embodiments of the invention includes a rental article and a station as elements. As illustrated in FIG. 1, the rental article may include a plurality of rental articles such as a first rental article 111, a second rental article 112, a third rental article 113, and a fourth rental article 114, and the station may also include a plurality of stations such as a first station 121, a second station 122, and a third station 123.

The rental article performs a function of converting collected solar energy into electric energy, and may be any one of a bicycle, a parasol, and a cap according to embodiments. In addition, the rental articles are not limited to the embodiment as long as it can collect solar power, and all targets may be the rental articles of the invention, at least in some embodiments. In addition, the station is positioned in a space for renting and returning the rental article and, for example, when the rental article is a bicycle, the station may be mounted on a binder device for renting and returning a bicycle. Alternatively, the station may be mounted on a POS or a PC for renting and returning a bicycle.

As illustrated in FIG. 1, the first rental article 111 is rented in the first station 121 and is returned to the first station 121, the second rental article 112 is rented in the first station 121 and is returned to the third station 123, the third rental article 113 is rented in the second station 122 and is returned to the first station 121, and the fourth rental article 114 is rented in the third station 123 and is returned to the second station 122. In other words, the station located in the space for renting each rental article and the station located in the space for returning the rental article may be the same or different from each other.

Hereinafter, a configuration of a rental article in a distributed generation system of a rental article using a flexible thin film solar cell according to some embodiments of the invention will be described in detail.

As illustrated in FIG. 2, the rental article 110 includes a power generating unit 110a, a rental article energy storing unit 110b, and a rental article energy using unit 110c. Specifically in each constituent element, the power generating unit 110a is positioned outside the rental article, and performs a function of collecting solar energy and converting the collected solar energy into electric energy. Accordingly, it is preferable that the power generating unit 110a is provided at a position for most efficiently collecting solar energy considering features of configurations of various rental articles according to the embodiment. It is preferable that such a power generating unit 110a is a flexible thin film solar cell. As described above, since the flexible thin film solar cell has an advantage of being light and flexible, it is easy to mount the flexible thin film solar cell to the rental article disclosed in the invention, at least in some embodiments.

In addition, the rental article energy storing unit 110b performs a function of storing the electric energy provided from the power generating unit 110a or the station 120 illustrated in FIG. 3. Although details will be described later, the rental article energy storing unit 110b stores electric energy, but does not only stores the electric energy generated in the power generating unit 110a, and it may store electric energy provided from the station 120. Therefore, the rental article energy storing unit 110b is electrically connected to the power generating unit 110a.

In some embodiments, the rental article energy storing unit 110b may include at least one of a super cap or a secondary battery to store electric energy transmitted from the power generating unit 110a.

In addition, the rental article energy using unit 110c performs a function of operating the rental article 110 using the electric energy stored in the rental article energy storing unit 110b. For example, when the rental article is an electric bicycle, the rental article energy using unit 110c performs a function of using the electric energy stored in the rental article energy storing unit 110b to operate the electric bicycle.

In addition, in some embodiments, as illustrated in FIGS. 6 and 7, the rental article may be a snowboard or a stroller. In this case, the snowboard or the stroller can convert solar energy into electric energy and, for example, when the rental article is the stroller as illustrated in FIG. 7, the power generating unit 110a may be configured in a sunscreen shape, and may include the rental article energy storing unit and the rental article energy using unit. Herein, the rental article energy using unit may be a blower fan. In other words, the electric energy is generated through the power generating unit having the sunscreen shape, and the blower fan may use the generated electric energy.

Hereinafter, a configuration of the station in the distributed generation system of a rental article using a flexible thin film solar cell according to some embodiments of the invention will be described in detail.

As illustrated in FIG. 3, the station 120 includes an energy connecting unit 120a, a station energy storing unit 120b, and a station energy using unit 120c. More specifically in each constituent element, the energy connecting unit 120a performs a function of receiving electric energy from the rental article energy storing unit 110b or providing electric energy to the rental article energy storing unit 110b. As described above, the rental article energy storing unit 110b does not store only the electric energy generated in the power generating unit 110a, and may also store the electric energy provided by the station 120.

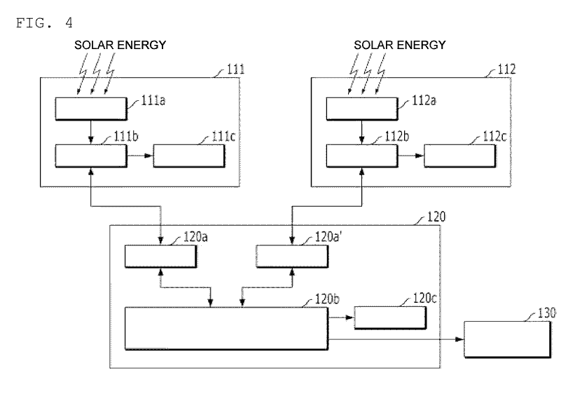

In addition, as described above, a plurality of rental articles may be provided, and a plurality of energy connecting units 120a may be provided corresponding to the rental articles. A specific embodiment will be described later with reference to FIG. 4.

In addition, the station energy storing unit 120b performs a function of storing the electric energy provided from the rental energy storing unit 110b and providing the electric energy to the power demand target. Herein, the power demand target may be any one rental article of the plurality of rental articles, and any one station of the plurality of stations, and any facility other than the rental articles and the stations disclosed in at least certain embodiments of the invention may be the power demand target described in the specification as long as it is a target which requires power.

In addition, the station energy using unit 120c performs a function of operating the station 120 using the electric energy stored in the station energy storing unit 120b.

Hereinafter, an embodiment of the distributed generation system of a rental article using a flexible thin film solar cell according to the invention will be described with reference to FIG. 4. FIG. 4 is a diagram for explaining an embodiment of the distributed generation system of a rental article using a flexible thin film solar cell according to the invention.

Referring to FIG. 4, the first rental article 111 includes a power generating unit 111a, a rental article energy storing unit 111b, and a rental article energy using unit 111c, and the second rental article 112 also includes a power generating unit 112a, a rental article energy storing unit 112b, and a rental article energy using unit 112c.

In this case, the station 120 includes a plurality of energy connecting units 120a and 120a′. In other words, the station may include a plurality of energy connecting units, and the energy connecting units are configured corresponding to the rental articles, respectively. More specifically, the first rental article 111 is connected to the energy connecting unit 120a, and the second rental article is connected to the energy connecting unit 120a′. In addition, the plurality of energy connecting units are connected to the station energy storing unit 120b, and the station energy storing unit 120b is connected to the station energy using unit 120c.

According to the embodiment, the first rental article 111 is an electric bicycle, and the electric bicycle converts and generates solar energy into electric energy through the power generating unit 111a. In this case, the generated electric energy is stored in the rental article energy storing unit 111b, and the electric bicycle may be operated differently according to whether energy sufficient for operating the electric bicycle is stored or sufficient energy is not stored. In other words, when the electric energy generated in the power generating unit 111a is sufficient and the energy sufficient for operating the electric bicycle is stored, it is possible to provide the electric energy to the station energy storing unit 120b through the connecting unit 120a of the station 120. However, when the energy sufficient for operating the electric bicycle is not generated in the power generating unit 111a, the operating of the electric bicycle is first of all, and thus the electric energy may not be provided to the station.

As described above, when the electric energy is provided from the rental article 111 to the station 120, the station 120 stores the provided electric energy, the station 120 itself may consume the electric energy through the station energy using unit 120c or may provide the electric energy to the second rental article or the power demand target 130.

As described above, the electric energy generated in the plurality of rental articles is collected in the station, there is an advantage that a great amount of electric energy can be collected, and the collected electric energy can be provided to the other rental article or the power demand target.

Hereinafter, a distributed generation method of a rental article using a flexible thin film solar cell according to some embodiments of the invention will be described. As described above, the description of the technique overlapped with that of the distributed generation system of a rental article using a flexible thin film solar cell according to some embodiments of the invention is omitted.

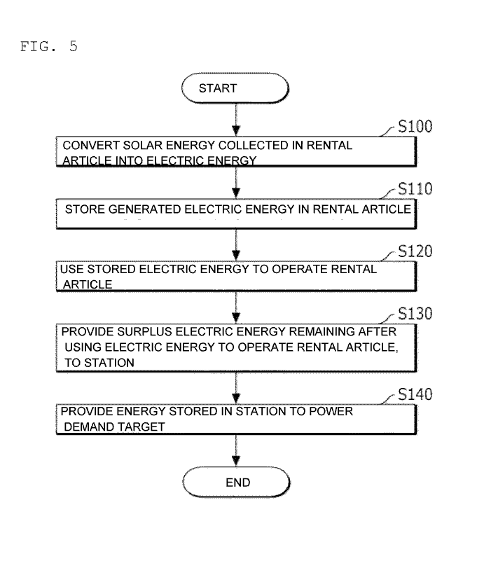

FIG. 5 is a flowchart illustrating a distributed generation method of a rental article using a flexible thin film solar cell according to some embodiments of the invention.

Referring to FIG. 5, in the distributed generation method of a rental article using a flexible thin film solar cell according to some embodiments of the invention, first, Step S100 of converting solar energy collected in a rental article into electric energy is performed. Step S100 is performed in the power generating unit. Then, Step S110 of storing the generated electric energy in the rental article is performed. Specifically, the generated electric energy is stored in the rental article energy storing unit of the rental article. Then, Step S120 of using the stored electric energy to operate the rental article is performed. Step S120 is performed in the rental article energy using unit. After Step S120, Step S130 of providing surplus electric energy, which remains after using the electric energy to operate the rental article, is performed. Then, Step S140 of providing the energy stored in the station to the power demand target is performed, and the process is ended.

According to the embodiment, the station in Step S130 of providing the surplus electric energy, which remains after using the electric energy to operate the rental article, of the stored electric energy to the station, may be a second station positioned in a space different from a first station positioned in a space for renting the rental article, and the second station may be positioned in a space for returning the rental article.

As described above, the distributed generation system and method of a rental article using a flexible thin film solar cell according to at least some embodiments of the invention have an advantage that the rental article to which the flexible thin film solar cell is attached generates power, and the generated power can be used or the surplus power of the generated power can be provided to the power demand target, and have an effect of achieving reduction of greenhouse gas.

In the invention described above, at least in some embodiments, the configurations and methods of the embodiments described above are not definitively applied, and a part of all of the embodiments may be alternatively combined and configured such that the embodiments can be variously modified.

According to the invention, at least in some embodiments, a rental article to which a flexible solar thin film cell is attached generates power, and it is possible to use the generated power or to provide surplus power of the generated power to a power demand target.

In addition, according to the invention, at least in some embodiments, it is possible to achieve reduction of greenhouse gas by generating electric energy from a rental article itself.

While the present invention has been described with respect to the specific embodiments, it will be apparent to those skilled in the art that various changes and modifications may be made without departing from the spirit and scope of the invention as defined in the following claims.

What is claimed is:

1. A distributed energy generation system of a rental article using a flexible thin film solar cell, comprising:
a rental article which generates electric energy from collected solar energy; and
a station which is positioned in a space for renting and returning the rental article, and distributes and transmits electric energy provided from the rental article to a power demand target.

2. The distributed energy generation system of a rental article using a flexible thin film solar cell according to claim 1, wherein the rental article includes:
a power generating unit which is positioned outside the rental article, collects solar energy, and converts the collected solar energy into electric energy;
an energy storing unit which stores the electric energy provided from the power generating unit or the station; and
a rental article energy utilization unit which operates the rental article using the electric energy stored in the rental article energy storing unit.

3. The distributed energy generation system of a rental article using a flexible thin film solar cell according to claim 2, wherein the power generating unit is a flexible thin film solar cell.

4. The distributed energy generation system of a rental article using a flexible thin film solar cell according to claim 2, wherein the station includes:
an energy connecting unit which receives the electric energy from the rental article energy storing unit, or provides the electric energy to the rental article storing unit;
a station energy storing unit which stores the electric energy provided from the rental article energy storing unit, and provides the electric energy to the power demand target; and
a station energy using unit which operates the station using the electric energy stored in the station energy storing unit.

5. The distributed energy generation system of a rental article using a flexible thin film solar cell according to claim 4, wherein a plurality of rental articles is prepared, and a plurality of energy connecting units are provided corresponding to the rental articles.

6. The distributed energy generation system of a rental article using a flexible thin film solar cell according to claim 4, wherein the station energy storing unit receives electric energy from an energy storing unit of a first rental article through a first energy connecting unit, and an energy storing unit of a second rental article receives the electric energy stored in the station energy storing unit through a second energy connecting unit.

7. The distributed energy generation system of a rental article using a flexible thin film solar cell according to claim 1, wherein the rental article is any one of a bicycle, a parasol, and a cap.

8. A distributed energy generation method using the distributed generation system of a rental article using a flexible thin film solar cell according to claim 1, comprising:
generating electric energy from solar energy collected in the rental article;
storing the generated electric energy in the rental article;
using the stored electric energy to operate the rental article; and
providing surplus electric energy, which remains after using to operate the rental article, of the stored electric energy to the station.

9. The distributed energy generation method of a rental article using a flexible thin film solar cell according to claim 8, further comprising, after providing surplus electric energy, which remains after using to operate the rental article, of the stored electric energy to the station, providing the electric energy stored in the station to a power demand target.

10. The distributed energy generation method of a rental article using a flexible thin film solar cell according to claim 9, wherein the power demand target is a second rental article.

11. The distributed energy generation method of a rental article using a flexible thin film solar cell according to claim 8, wherein the station in providing surplus electric energy, which remains after using to operate the rental article, of the stored electric energy to the station is a second station positioned in a space different from that of a first station positioned in a space for rental of the rental article, and is positioned in a space for return of the rental article.
